(19) United States
(12) Patent Application Publication
(10) Pub. No.: US 2011/0090155 A1
(43) Pub. Date: Apr. 21, 2011

(54) METHOD, SYSTEM, AND COMPUTER PROGRAM PRODUCT COMBINING GESTURAL INPUT FROM MULTIPLE TOUCH SCREENS INTO ONE GESTURAL INPUT

(75) Inventors: Mark S. Caskey, San Diego, CA (US); Sten Jorgen Ludvig Dahl, San Diego, CA (US); Thomas E. Kilpatrick, II, San Diego, CA (US)

(73) Assignee: QUALCOMM Incorporated, San Diego, CA (US)

(21) Appl. No.: 12/781,453

(22) Filed: May 17, 2010

Related U.S. Application Data
(60) Provisional application No. 61/252,075, filed on Oct. 15, 2009.

(51) Int. Cl. G06F 3/041

(52) U.S. Cl. 345/173

(57) ABSTRACT

A method for use by a touch screen device includes detecting a first touch screen gesture at a first display surface of an electronic device, detecting a second touch screen gesture at a second display surface of the electronic device, and discerning that the first touch screen gesture and the second touch screen gesture are representative of a single command affecting a display on the first and second display surfaces.

### CROSS-REFERENCE TO RELATED APPLICATION

The present application claims the benefit of U.S. Provisional Application No. 61/252,075, filed Oct. 15, 2009, and entitled “MULTI-PANEL ELECTRONIC DEVICE,” the disclosure of which is expressly incorporated herein by reference in its entirety.

### TECHNICAL FIELD

The present disclosure is generally related to a multi-touch screen electronic device and, more specifically, to systems, methods, and computer program products that recognize touch screen inputs from multiple touch screens.

### BACKGROUND

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and internet protocol (IP) telephones, can communicate voice and data packets over wireless networks. Further, many such portable wireless telephones include other types of devices that are incorporated therein. For example, a portable wireless telephone can also include a digital still camera, a digital video camera, a digital recorder, and an audio file player. Also, such wireless telephones can process executable instructions, including software applications, such as a web browser application, that can be used to access the Internet. As such, these portable wireless telephones can include significant computing capabilities.

Although such portable devices may support software applications, the usefulness of such portable devices is limited by a size of a display screen of the device. Generally, smaller display screens enable devices to have smaller form factors for easier portability and convenience. However, smaller display screens limit an amount of content that can be displayed to a user and may therefore reduce a richness of the user's interactions with the portable device.

### BRIEF SUMMARY

According to one embodiment, a method for use by an electronic device that includes multiple touch screens is disclosed. The method includes detecting a first touch screen gesture at a first display surface of the electronic device, detecting a second touch screen gesture at a second display surface of the electronic device, and discerning that the first touch screen gesture and the second touch screen gesture are representative of a single command affecting a display on the first and second display surfaces.

According to another embodiment, an apparatus is disclosed. The apparatus includes a first display surface comprising a first touch-sensitive input mechanism configured to detect a first touch screen gesture at the first display surface and a second display surface comprising a second touch-sensitive input mechanism configured to detect a second touch screen gesture at the second display surface. The apparatus also includes a device controller in communication with the first display surface and with the second display surface. The device controller combining the first touch screen gesture and the second touch screen gesture into a single command affecting a display at the first and second display surfaces.

According to one embodiment, a computer program product having a computer readable medium tangibly storing computer program logic is disclosed. The computer program product includes code to recognize a first touch screen gesture at a first display surface of an electronic device, code to recognize a second touch screen gesture at a second display surface of the electronic device; and code to discern that the first touch screen gesture and the second touch screen gesture are representative of a single command affecting at least one visual item displayed on the first and second display surfaces.

According to yet another embodiment, an electronic device is disclosed. The electronic device includes a first input means for detecting a first touch screen gesture at a first display surface of the electronic device and a second input means for detecting a second touch screen gesture at a second display surface of the electronic device. The electronic device also includes means in communication with the first input means and the second input means for combining the first touch screen gesture and the second touch screen gesture into a single command affecting at least one displayed item on the first and second display surfaces.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific embodiments disclosed may be readily utilized as a basis for modifying or designing other structures for carrying out the same purposes of the present disclosure. It should also be realized by those skilled in the art that such equivalent constructions do not depart from the technology of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is an illustration of a first embodiment of an electronic device.

FIG. 2 depicts the example electronic device of FIG. 1 in a fully extended configuration.

FIG. 3 is a block diagram of processing blocks included in the example electronic device of FIG. 1.

FIG. 4 is an exemplary state diagram of the combined gesture recognition engine of FIG. 3, adapted according to one embodiment.

FIG. 5 is an illustration of an exemplary process of recognizing multiple touch screen gestures at multiple display surfaces of an electronic device as representative of a single command, according to one embodiment.

FIG. 6 is an example illustration of a hand of a human user entering gestures upon multiple screens of the device of FIG. 2.

### DETAILED DESCRIPTION

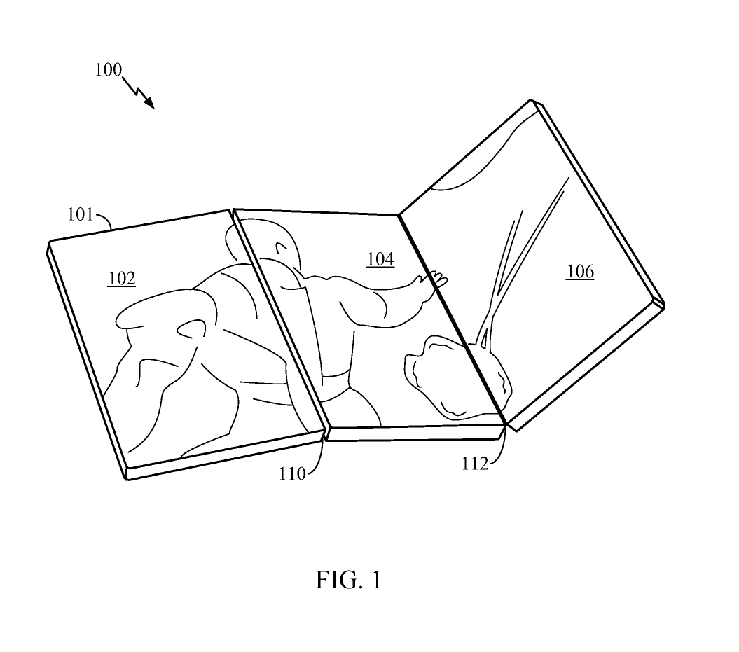

Referring to FIG. 1, a first illustrated embodiment of an electronic device is depicted and generally designated 100. The electronic device 101 includes a first panel 102, a second panel 104, and a third panel 106. The first panel 102 is coupled to the second panel 104 along a first edge at a first fold location 110. The second panel 104 is coupled to the third panel 106 along a second edge of the second panel 104, at a second fold location 112. Each of the panels 102, 104, and 106 includes a display surface configured to provide a visual display, such as a liquid crystal display (LCD) screen. The electronic device 101 can be any kind of touch screen device, such as a mobile device (e.g., a smart phone or position locating device), a desktop computer, a notebook computer, a media player, or the like. The electronic device 101 is configured to automatically adjust a user interface or to display images when a user enters various touch gestures spanning one or more of the panels 102, 104, and 106.

As depicted in FIG. 1, the first panel 102 and the second panel 104 are rotatably coupled at the first fold location 110 to enable a variety of device configurations. For example, the first panel 102 and the second panel 104 may be positioned such that the display surfaces are substantially coplanar to form a substantially flat surface. As another example, the first panel 102 and the second panel 104 may be rotated relative to each other around the first fold location 110 until a back surface of the first panel 102 contacts a back surface of the second panel 104. Likewise, the second panel 104 is rotatably coupled to the third panel 106 along the second fold location 112, enabling a variety of configurations including a fully folded, closed configuration where the display surface of the second panel 104 contacts the display surface of the third panel 106 and a fully extended configuration where the second panel 104 and the third panel 106 are substantially coplanar.

In a particular embodiment, the first panel 102, the second panel 104, and the third panel 106 may be manually configured into one or more physical folded states. By enabling the electronic device 101 to be positioned in multiple foldable configurations, a user of the electronic device 101 may elect to have a small form factor for easy maneuverability and functionality or may elect an expanded, larger form factor for displaying rich content and to enable more significant interaction with one or more software applications via expanded user interfaces.

When fully extended, the electronic device 101 can provide a panorama view similar to a wide screen television. When fully folded to a closed position, the electronic device 101 can provide a small form factor and still provide an abbreviated view similar to a cell phone. In general, the multiple configurable displays 102, 104, and 106 may enable the electronic device 101 to be used as multiple types of devices depending on how the electronic device 101 is folded or configured.

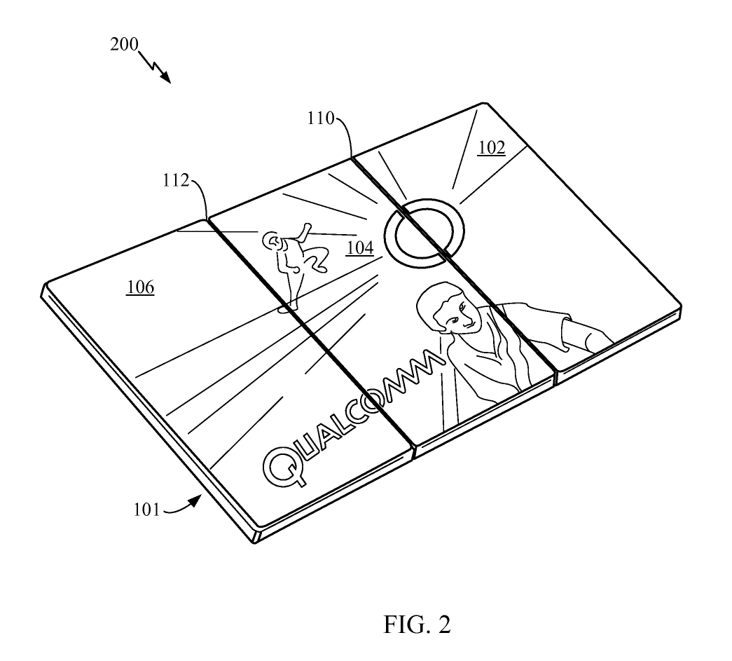

FIG. 2 depicts the electronic device 101 of FIG. 1 in a fully extended configuration 200. The first panel 102 and the second panel 104 are substantially coplanar, and the second panel 104 is substantially coplanar with the third panel 106. The panels 102, 104, and 106 may be in contact at the first fold location 110 and the second fold location 112 such that the display surfaces of the first panel 102, the second panel 104, and the third panel 106 effectively form an extended, three-panel display screen. As illustrated, in the fully extended configuration 200, each of the display surfaces displays a portion of a larger image, with each individual display surface displaying a portion of the larger image in a portrait mode, and the larger image extending across the effective three-panel screen in a landscape mode. Alternatively, although not shown herein, each of the panels 102, 104, 106 may show a different image or multiple different images, and the displayed content may be video, still images, electronic documents, and the like.

As shown in the following FIGURES, each of the panels 102, 104, 106 is associated with a respective controller and driver. The panels 102, 104, 106 include touch screens that receive input from a user in the form of one or more touch gestures. For instance, gestures include drags, pinches, points, and the like that can be sensed by a touch screen and used to control the display output, to enter user selections, and the like. Various embodiments receive multiple and separate gestures from multiple panels and combine some of the gestures, from more than one panel, into a single gesture. For instance, a pinch gesture wherein one finger is on the panel 102 and another finger is on the panel 104 is interpreted as a single pinch rather than two separate drags. Other examples are described further below.

It should be noted that the examples herein show a device with three panels, though the scope of embodiments is not so limited. For instance, embodiments can be adapted for use with devices that have two or more panels as the concepts described herein are applicable to a wide variety of multi-touch screen devices.

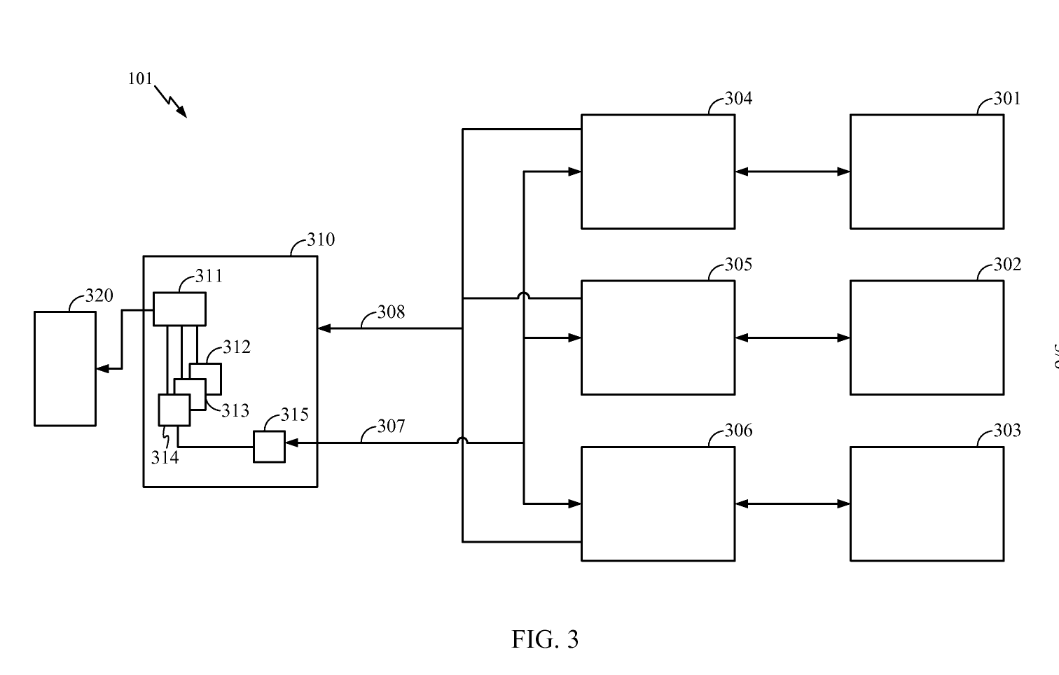

FIG. 3 is a block diagram of processing blocks included in the example electronic device 101 of FIG. 1. The device 101 includes three touch screens 301-303. Each of the touch screens 301-303 is associated with a respective touch screen controller 304-306, and the touch screen controllers 304-306 are in communication with the device controller 310 via the data/control bus 307 and the interrupt bus 308. Various embodiments may use one or more data connections, such as an Inter-Integrated Circuit (I²C) bus or other connection as may be known or later developed for transferring control and/or data from one component to another. The data/control signals are interfaced using a data/control hardware interface block 315.

The touch screen 301 may include or correspond to a touch-sensitive input mechanism that is configured to generate a first output responsive to one or more gestures such as a touch, a sliding or dragging motion, a release, other gestures, or any combination thereof. For example, the touch screen 301 may use one or more sensing mechanisms such as resistive sensing, surface acoustic waves, capacitive sensing, strain gauge, optical sensing, dispersive signal sensing, and/or the like. The touch screens 302 and 303 operate to generate output in a substantially similar manner as the touch screen 301.

The touch screen controllers 304-306 receive electrical input associated with a touch event from the corresponding touch-sensitive input mechanisms and translate the electrical input into coordinates. For instance, the touch screen controller 304 may be configured to generate an output including position and location information corresponding to a touch gesture upon the touch screen 301. The touch screen controllers 305, 306 similarly provide output with respect to gestures upon respective touch screens 302, 303. One or more of the touch screen controllers 304-306 may be configured to operate as a multi-touch controlling circuit that is operable to generate position and location information corresponding to multiple concurrent gestures at a single touch screen. The touch screen controllers 304-306 individually report the finger location/position data to the device controller 310 via the connection 307.

In one example, the touch screen controllers 304-306 respond to a touch to interrupt the device controller 310 via the interrupt bus 308. Upon receipt of the interrupt the device controller 310 polls the touch screen controllers 304-306 to retrieve the finger location/position data. The finger location/position data is interpreted by the drivers 312-314, which each interpret the received data as a type of touch (e.g., a point, a swipe, etc.). The drivers 312-314 may be hardware, software, or a combination thereof, and in one embodiment include low level software drivers, each driver 312-314 dedicated to an individual touch screen controller 304-306. The information from the drivers 312-314 is passed up to the combined gesture recognition engine 311. The combined gesture recognition engine 311 may also be hardware, software, or a combination thereof, and in one embodiment is a higher level software application. The combined gesture recognition engine 311 recognizes the information as a single gesture on one screen or a combined gesture on two or more screens. The combined gesture recognition engine 311 then passes the gesture to an application 320 running on the electronic device 101 to perform the required operation, such as a zoom, a flip, a rotation, or the like. In one example, the application 320 is a program executed by the device controller 310, although the scope of embodiments is not so limited. Thus, user touch input is interpreted and then used to control the electronic device 101 including, in some instances, applying user input as a combined multi-screen gesture.

The device controller 310 may include one or more processing components such as one or more processor cores and/or dedicated circuit elements configured to generate display data corresponding to content to be displayed upon the touch screens 301-303. The device controller 310 may be configured to receive information from the combined gesture recognition engine 311 and to modify visual data displayed upon one or more of the touch screens 301-303. For example, in response to a user command indicating a counter-clockwise rotation, the device controller 310 may perform calculations corresponding to a rotation of content displayed upon the touch screens 301-303 and send updated display data to the application 320 to cause one or more of the touch screens 301-303 to display rotated content.

During operation, the combined gesture recognition engine 311 combines gestural input from two or more separate touch screens into one gestural input indicating a single command on a multi-screen device. Interpreting gestural inputs provided by a user at multiple screens simultaneously, or substantially concurrently, may enable an intuitive user interface and enhanced user experience. For example, a “zoom in” command or a “zoom out” command may be discerned from sliding gestures detected on adjacent panels, each sliding gesture at one panel indicating movement in a direction substantially away from the other panel (e.g., zoom in) or toward the other panel (e.g., zoom out). In a particular embodiment, the combined gesture recognition engine 311 is configured to recognize a single command to emulate a physical translation, rotation, stretching, or a combination thereof, or a simulated continuous display surface that spans multiple display surfaces, such as the continuous surface shown in FIG. 2.

In one embodiment, the electronic device 101 includes a pre-defined library of gestures. In other words, in this example embodiment, the combined gesture recognition engine 311 recognizes a finite number of possible gestures, some of which are single gestures and some of which are combined gestures on one or more of the touch screens 301-303. The library may be stored in memory (not shown) so that it can be accessed by the device controller 310.

In one example, the combined gesture recognition engine 311 sees a finger drag on the touch screen 301 and another finger drag on the touch screen 302. The two finger drags indicate the two fingers are approaching each other on top of the display surface within a certain window, e.g., a few milliseconds. Using such information (i.e., two mutually approaching fingers within a time window), and any other relevant contextual data, the combined gesture recognition engine 311 searches the library for a possible match, eventually settling on a pinch gesture. Thus, in some embodiments, combining gestures includes searching a library for a possible corresponding combined gesture. However, the scope of embodiments is not so limited, as various embodiments may use any technique now known or later developed to combine gestures including, e.g., one or more heuristic techniques.

Furthermore, a particular application may support only a subset of the total number of possible gestures. For instance, a browser might have a certain number of gestures that are supported, and a photo viewing application might have a different set of gestures that are supported. In other words, gesture recognitions may be interpreted differently from one application to another application.

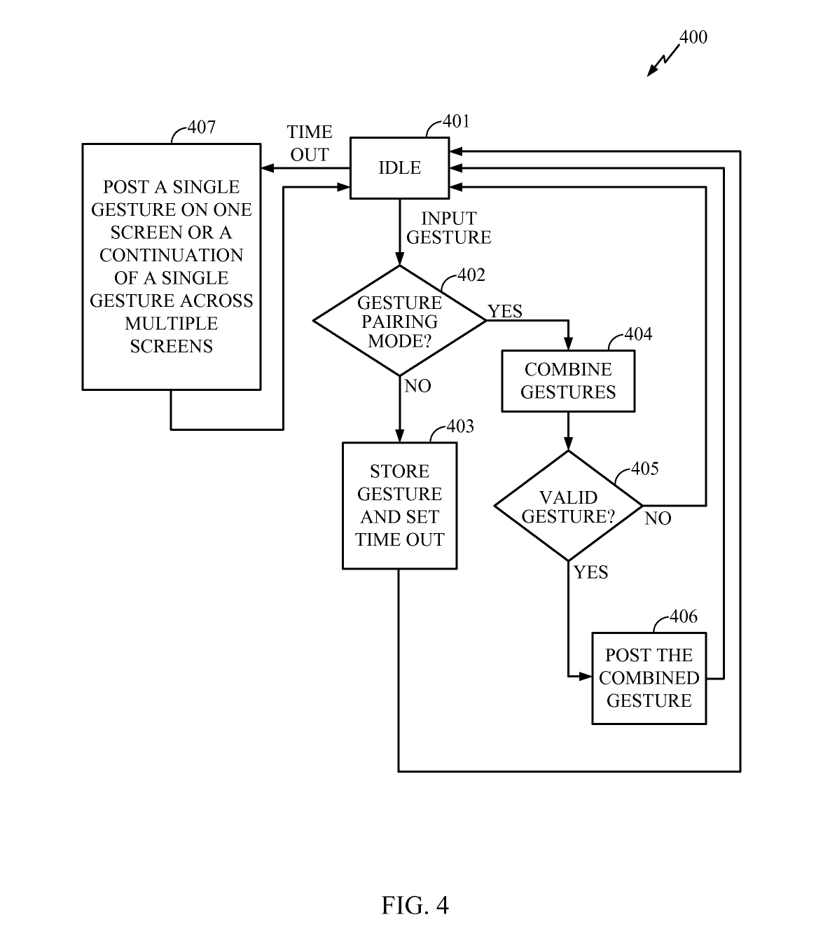

FIG. 4 is an exemplary state diagram 400 of the combined gesture recognition engine 311 of FIG. 3, adapted according to one embodiment. The state diagram 400 represents the operation of an embodiment, and it is understood that other embodiments may have state diagrams that differ somewhat. State 401 is an idle state. When an input gesture is received, the device checks whether it is in gesture pairing mode at state 402. In this example, a gesture pairing mode is a mode wherein at least one gesture has already been received and the device is checking to see if the gesture should be combined with one or more other gestures. If the device is not in a gesture pairing mode, it stores the gesture and sets a time out at state 403 and then returns to the idle state 401. After the time out expires, the device posts a single gesture on one screen at state 407.

If the device is in a gesture pairing mode, the device combines the received gesture with another previously stored gesture at state 404. In state 405, the device checks whether the combined gesture corresponds to a valid gesture. For instance, in one embodiment, the device looks at the combined gesture information, and any other contextual information, and compares it to one or more entries in a gesture library. If the combined gesture information does not correspond to a valid gesture, then the device returns to the idle state 401 so that the invalid combined gesture is discarded.

On the other hand, if the combined gesture information does correspond to a valid combined gesture, then the combined gesture is posted on one or more screens at state 406. The device then returns to the idle state 401.

Of note in FIG. 4 is the operation of the device with respect to a continuation of a single gesture across multiple screens. An example of such a gesture is a finger swipe that traverses parts of at least two screens. Such a gesture can be treated as either a single gesture on multiple screens or multiple gestures, each on a different screen, that are added and appear continuous to a human user.

In one embodiment, as shown in FIG. 4, such a gesture is treated as multiple gestures that are added. Thus, in the case of a drag across multiple screens, the drag on a given screen is a single gesture on that screen, and the drag on the next screen is another single gesture that is a continuation of the first single gesture. Both are posted at state 407. When gestures are posted at states 406 and 407, information indicative of the gesture is passed to an application (such as the application 320 of FIG. 3) that controls the display.

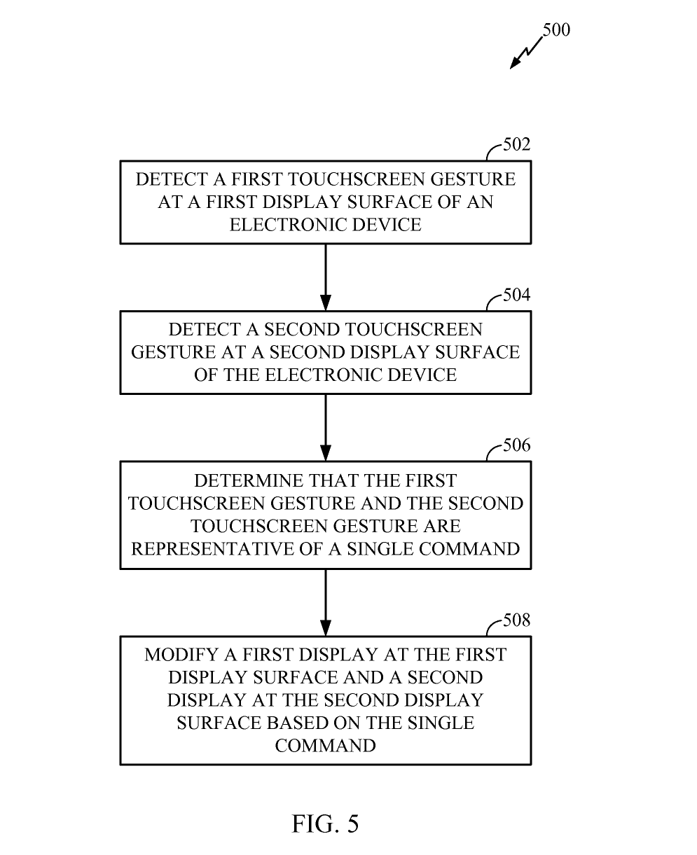

FIG. 5 is an illustration of an exemplary process 500 of recognizing multiple touch screen gestures at multiple display surfaces of an electronic device as representative of a single command, according to one embodiment. In a particular embodiment, the process 500 is performed by the electronic device 101 of FIG. 1.

The process 500 includes detecting a first touch screen gesture at a first display surface of an electronic device, at 502. For example, referring to FIG. 3, the first gesture may be detected at the touch screen 301. In some embodiments, the gesture is stored in a memory so that it can be compared, if needed, to a concurrent or later gesture.

The process 500 also includes detecting a second touch screen gesture at a second display surface of the electronic device at 504. In the example of FIG. 3, the second gesture may be detected at the touch screen 302 (and/or the touch screen 303, but for ease of illustration, this example focuses upon the touch screens 301, 302). In a particular embodiment, the second touch screen gesture may be detected substantially concurrently with the first touch screen gesture. In another embodiment, the second gesture may be detected soon after the first touch screen gesture. In any event, the second gesture may also be stored in a memory. The first and second gestures may be recognized from position data using any of a variety of techniques. The blocks 502, 504 may include detecting/storing the row position data and/or storing processed data that indicates the gestures themselves.

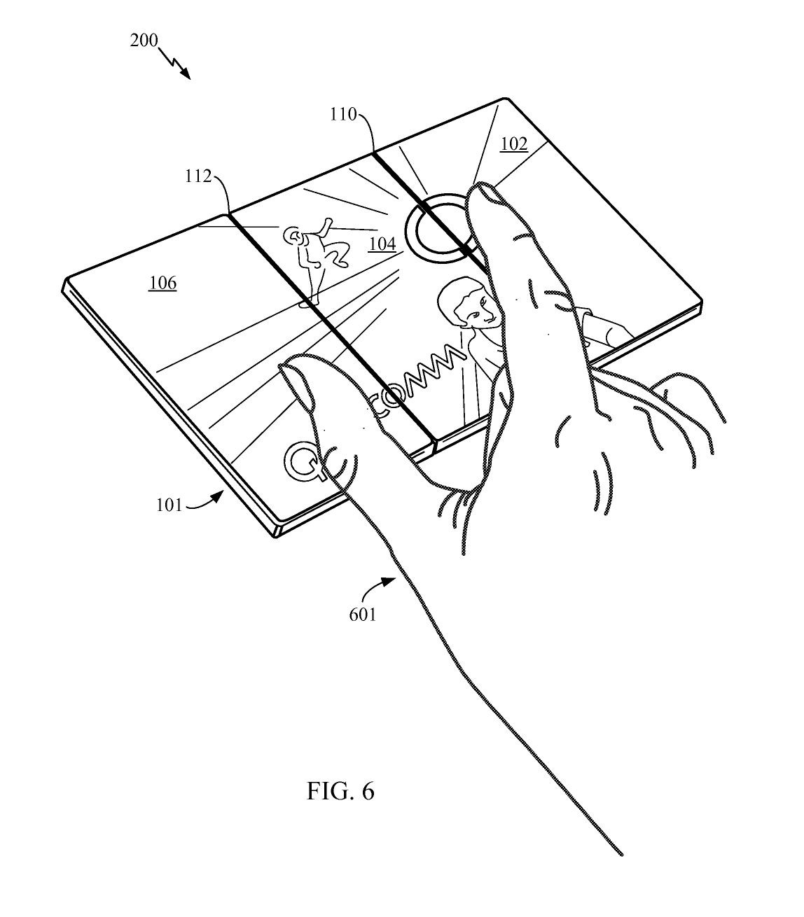

FIG. 6 shows a hand 601 performing gestures upon two different screens of the device of FIG. 2. In the example of FIG. 6, the hand 601 is performing a pinch across two different screens to manipulate the display. The various embodiments are not limited to pinch gestures, as explained above and below.

The process 500 further includes determining that the first touch screen gesture and the second touch screen gesture are representative of, or otherwise indicate, a single command at 506. Returning to the example of FIG. 3, the combined gesture recognition engine 311 determines that the first gesture and the second gesture are representative of, or indicate, a single command. For example, two single gestures closely but tightly coupled sequentially in time occurring from one touch screen to another may be interpreted as yet another command in the library of commands. The combined gesture recognition engine 311 looks in the library of commands and determines that the gesture is a combined gesture that includes a swipe across multiple touch screens.

Examples of combined gestures stored in the library can include, but are not limited to the following examples. As a first example, a single drag plus a single drag may be one of three possible candidates. If the two drags are in substantially opposite directions away from each other, then it is likely that the two drags together are a combined pinch out gesture (e.g., for a zoom-out). If the two drags are in substantially opposite directions toward each other, then it is likely that the two drags together are a combined pinch in gesture (e.g., for a zoom-in). If the two drags are tightly coupled and sequential and in the same direction, it is likely that the two drags together are a combined multi-screen swipe (e.g., for scrolling).

Other examples include a point and a drag. Such a combination may be indicative of a rotation in the direction of the drag with the finger point acting as a pivot point. A pinch plus a point may be indicative of a skew that affects the dimensions of a displayed object at the pinch but not at the point. Other gestures are possible and within the scope of embodiments. In fact, any detectable touch screen gesture combination now known or later developed may be used by various embodiments. Furthermore, the various commands that may be accessed are unlimited and may also include commands not mentioned explicitly above, such as copy, paste, delete, move, etc.

The process 500 includes modifying a first display at the first display surface and a second display at the second display surface based on the single command, at 508. For example, referring to FIG. 3, the device controller 310 sends the combined gesture to the application 320, which modifies (e.g., rotates clockwise, rotates counter-clockwise, zooms-in, or zooms-out) the display at the touch screens 301 and 302. In a particular embodiment, the first display and the second display are operable to display a substantially continuous visual display. The application 320 then modifies one or more visual elements of the visual display, across one or more of the screens, according to the recognized user command. Thus, a combined gesture may be recognized and acted upon by a multi-panel device. Of course, the third display 303 could also be modified based upon the command, in addition to the first and second displays 301 and 302.

Those of skill will further appreciate that the various illustrative logical blocks, configurations, modules, circuits, and algorithm steps described in connection with the embodiments disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a process or algorithm described in connection with the embodiments disclosed herein may be embodied directly in hardware, in a software module executed by a processor, or in a combination of the two. A software module may reside in a tangible storage medium such as a random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of tangible storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

Moreover, the previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the features shown herein but is to be accorded the widest scope consistent with the principles and novel features disclosed herein.

Although the present disclosure and its advantages have been described in detail, it should be understood that various changes, substitutions and alterations can be made herein without departing from the technology of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for use by an electronic device that includes multiple touch screens, the method comprising:
detecting a first touch screen gesture at a first display surface of the electronic device;
detecting a second touch screen gesture at a second display surface of the electronic device; and
discerning that the first touch screen gesture and the second touch screen gesture are representative of a single command affecting a display on the first and second display surfaces.

2. The method of claim 1, further comprising modifying the display at the first display surface and the second display surface based on the single command.

3. The method of claim 1, wherein the first touch screen gesture and the second touch screen gesture are each at least one of a touch, a sliding motion, a dragging motion, and a releasing motion.

4. The method of claim 1, wherein the single command is selected from the list consisting of:
a rotation command, a zoom command, and a scroll command.

5. The method of claim 1, wherein the first touch screen gesture and the second touch screen gesture are detected substantially concurrently.

6. The method of claim 1 performed by at least one of a cell phone, a notebook computer, and a desktop computer.

7. An apparatus, comprising:
a first display surface comprising a first touch-sensitive input mechanism configured to detect a first touch screen gesture at the first display surface;
a second display surface comprising a second touch-sensitive input mechanism configured to detect a second touch screen gesture at the second display surface; and
a device controller in communication with the first display surface and with the second display surface, the device controller combining the first touch screen gesture and the second touch screen gesture into a single command affecting a display at the first and second display surfaces.

8. The apparatus of claim 7 in which the first and second display surfaces comprise separate touch screen panels controlled by respective touch screen controllers, the respective touch screen controllers in communication with the device controller.

9. The apparatus of claim 8 in which the device controller executes first and second software drivers receiving touch screen position information from the respective touch screen controllers and translating the position information into the first and second touch screen gestures.

10. The apparatus of claim 7 further including an application receiving the single command from the device controller and modifying a first display at the first display surface and a second display at the second display surface based on the single command.

11. The apparatus of claim 7, further comprising a third display surface coupled to a first edge of the first display surface and second edge of the second display surface.

12. The apparatus of claim 7, wherein the first touch screen gesture and the second touch screen gesture each comprise at least one of a touch, a sliding motion, a dragging motion, and a releasing motion.

13. The apparatus of claim 7, wherein the single command includes a clockwise rotation command, a counter-clockwise rotation command, a zoom-in command, a zoom-out command, a scroll command, or any combination thereof

14. The apparatus of claim 7 comprising one or more of a cell phone, a media player, and a location device.

15. A computer program product having a computer readable medium tangibly storing computer program logic , the computer program product comprising:
code to recognize a first touch screen gesture at a first display surface of an electronic device;
code to recognize a second touch screen gesture at a second display surface of the electronic device; and
code to discern that the first touch screen gesture and the second touch screen gesture are representative of a single command affecting at least one visual item displayed on the first and second display surfaces.

16. The computer-readable storage medium of claim 15, wherein the computer executable code further comprises code to modify a first display at the first display surface and a second display at the second display surface based on the single command.

17. An electronic device comprising:
first input means for detecting a first touch screen gesture at a first display surface of the electronic device;
second input means for detecting a second touch screen gesture at a second display surface of the electronic device; and
means in communication with the first input means and the second input means for combining the first touch screen gesture and the second touch screen gesture into a single command affecting at least one displayed item on the first and second display surfaces.

18. The electronic device of claim 17 further comprising:
means for displaying an image at the first display surface and the second display surface; and
means for modifying the displayed image based on the single command.

19. The electronic device of claim 17 in which the first and second display surfaces comprise separate touch screen panels controlled by respective means for generating touch screen position information, the respective generating means in communication with the combining means.

20. The electronic device of claim 19 in which the combining means includes first and second means for receiving the touch screen position information from the respective generating means and translating the touch screen position information into the first and second touch screen gestures.
